(19) United States
(12) Patent Application Publication
(10) Pub. No.: US 2025/0071572 A1
(43) Pub. Date: Feb. 27, 2025

(54) BEAM CONTROL METHOD AND APPARATUS FOR WIRELESS AUXILIARY DEVICE AND NETWORK SIDE DEVICE

(71) Applicant: VIVO MOBILE COMMUNICATION CO., LTD., Dongguan (CN)

(72) Inventor: Kun YANG, Dongguan (CN)

(73) Assignee: VIVO MOBILE COMMUNICATION CO., LTD., Dongguan (CN)

(21) Appl. No.: 18/943,879

(22) Filed: Nov. 11, 2024

Related U.S. Application Data
(63) Continuation of application No. PCT/CN2023/093193, filed on May 10, 2023.

(30) Foreign Application Priority Data
May 12, 2022 (CN) 202210514852.7

(51) Int. Cl. H04W 16/28; H04B 7/06; H04L 5/00; H04W 24/02

(52) U.S. Cl. CPC H04W 16/28; H04B 7/06952; H04L 5/0051; H04W 24/02

(57) ABSTRACT

A beam control method for a wireless auxiliary device and a network side device are provided. The beam control method includes: receiving first configuration information from a network side device, where the first configuration information includes reference operating state information corresponding to a reference beam, the reference beam is a corresponding beam used by a wireless auxiliary device in a reference operating state to forward a signal of a first cell, and the first cell is a serving cell or a neighboring cell corresponding to the wireless auxiliary device. The wireless auxiliary device determines target operating state information of the wireless auxiliary device according to the first configuration information and first parameter information, to form a target beam, where the target beam is a corresponding beam used by the wireless auxiliary device in a target operating state to forward the signal of the first cell.

### CROSS-REFERENCE TO RELATED APPLICATIONS

This application is a continuation of International Application No. PCT/CN2023/093193, filed on May 10, 2023, which claims priority to Chinese Patent Application No. 202210514852.7, filed May 12, 2022. The entire contents of each of the above-identified applications are expressly incorporated herein by reference.

### TECHNICAL FIELD

This application pertains to the field of mobile communications technologies, and specifically, to a beam control method and apparatus for a wireless auxiliary device and a network side device.

### BACKGROUND

In a wireless auxiliary device-based communication network, a downlink signal of a serving cell or an uplink signal of a terminal is radiated to a wireless auxiliary device, and is reflected or transmitted by the wireless auxiliary device for forwarding. The wireless auxiliary device generates optimal beamforming by adjusting a signal forwarding state of each hardware unit, so that signal energy of a forwarding beam of the wireless auxiliary device is the strongest in a target direction. The wireless auxiliary device may be applied to a service scenario of serving cell signal enhancement.

In a multi-cell or multi-terminal scenario, radiation signals of the wireless auxiliary device include a wanted signal of the serving cell and an interference signal of a neighboring cell. Downlink signals of base stations of the serving cell and the neighboring cell are radiated to the wireless auxiliary device for forwarding. Therefore, the optimal beamforming of the wireless auxiliary device may increase interference signal strength of the neighboring cell in a case that the optimal beamforming of the wireless auxiliary device maximizes a signal of the serving cell, resulting in quality degradation of a received signal of the terminal.

### SUMMARY

Embodiments of this application provide a beam control method and apparatus for a wireless auxiliary device and a network side device.

According to a first aspect, a beam control method for a wireless auxiliary device is provided and applied to a wireless auxiliary device. The method includes:

The wireless auxiliary device receives first configuration information from a network side device, where the first configuration information includes reference operating state information corresponding to a reference beam, the reference beam is a corresponding beam used by the wireless auxiliary device in a reference operating state to forward a signal of a first cell, and the first cell is a serving cell or a neighboring cell corresponding to the wireless auxiliary device.

The wireless auxiliary device determines target operating state information of the wireless auxiliary device according to the first configuration information and first parameter information, to form a target beam, where the target beam is a corresponding beam used by the wireless auxiliary device in a target operating state to forward the signal of the first cell.

According to a second aspect, a beam control apparatus for a wireless auxiliary device is provided and includes:
a receiving module, configured to receive first configuration information from a network side device, where the first configuration information includes reference operating state information corresponding to a reference beam, the reference beam is a corresponding beam used by a beam control apparatus in a reference operating state to forward a signal of a first cell, and the first cell is a serving cell or a neighboring cell corresponding to the beam control apparatus; and
an execution module, configured to determine target operating state information according to the first configuration information and first parameter information, to form a target beam, where the target beam is a corresponding beam used by the beam control apparatus in a target operating state to forward the signal of the first cell.

According to a third aspect, a beam control method for a wireless auxiliary device is provided and applied to a network side device. The method includes:

The network side device sends first configuration information to a wireless auxiliary device, where the first configuration information includes reference operating state information corresponding to a reference beam, the reference beam is a corresponding beam used by the wireless auxiliary device in a reference operating state to forward a signal of a first cell, and the first cell is a serving cell or a neighboring cell corresponding to the wireless auxiliary device.

According to a fourth aspect, a beam control apparatus for a wireless auxiliary device is provided and includes:
a configuration module, configured to obtain first configuration information; and
a transmission module, configured to send the first configuration information to a wireless auxiliary device, where the first configuration information includes reference operating state information corresponding to a reference beam, the reference beam is a corresponding beam used by the wireless auxiliary device in a reference operating state to forward a signal of a first cell, and the first cell is a serving cell or a neighboring cell corresponding to the wireless auxiliary device.

According to a fifth aspect, a network side device is provided. The network side device includes a processor and a memory, the memory stores a program or an instruction that is executable on the processor, and the program or the instruction is executed by the processor to implement the steps of the method according to the third aspect.

According to a sixth aspect, a network side device is provided and includes a processor and a communication interface. The processor is configured to obtain first configuration information, and the communication interface is configured to send the first configuration information to a wireless auxiliary device.

According to a seventh aspect, a beam control system for a wireless auxiliary device is provided and includes a terminal, a wireless auxiliary device, and a network side device. The wireless auxiliary device may be configured to perform the steps of the beam control method for a wireless auxiliary device according to the first aspect, and the network side device may be configured to perform the steps of the beam control method for a wireless auxiliary device according to the third aspect.

According to an eighth aspect, a readable storage medium is provided, where the readable storage medium stores a program or an instruction, and the program or the instruction is executed by a processor to implement the steps of the method according to the first aspect or implement the steps of the method according to the third aspect.

According to a ninth aspect, a chip is provided. The chip includes a processor and a communication interface, the communication interface is coupled to the processor, and the processor is configured to run a program or an instruction to implement the method according to the first aspect or the method according to the third aspect.

According to a tenth aspect, a computer program/program product is provided. The computer program/program product is stored in a storage medium, and the computer program/program product is executed by at least one processor to implement the steps of the beam control method for a wireless auxiliary device according to the first aspect, or implement the steps of the beam control method for a wireless auxiliary device according to the third aspect.

In the embodiments of the application, the first configuration information is received from the network side device, where the first configuration information includes the reference operating state information corresponding to the reference beam, and then the target operating state information of the wireless auxiliary device is determined according to the first configuration information and the first parameter information, to form the target beam.

### BRIEF DESCRIPTION OF DRAWINGS

FIG. 1 is a schematic diagram of a structure of a wireless communication system according to some implementations of this application;

FIG. 2 is a flowchart of a beam control method for a wireless auxiliary device according to some implementations of this application;

FIG. 3 is a flowchart of another beam control method for a wireless auxiliary device according to some implementations of this application;

FIG. 4 is a schematic diagram of each mask pattern in a mask pattern candidate set according to some implementations of this application;

FIG. 5 is a schematic diagram of mask information of a wireless auxiliary device according to some implementations of this application;

FIG. 6 is a block diagram of a beam control apparatus for a wireless auxiliary device according to some implementations of this application;

FIG. 7 is a flowchart of another beam control method for a wireless auxiliary device according to some implementations of this application;

FIG. 8 is a block diagram of another beam control apparatus for a wireless auxiliary device according to some implementations of this application;

FIG. 9 is a block diagram of a communication device according to some implementations of this application; and

FIG. 10 is a block diagram of a network side device according to some implementations of this application.

### DETAILED DESCRIPTION

The following describes the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first,” “second,” and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in the description and the claims, “and/or” represents at least one of connected objects, and a character “/” generally represents an “or” relationship between associated objects.

It should be noted that technologies described in the embodiments of this application are not limited to a Long Term Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-Carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. A New Radio (NR) system is described in the following description for illustrative purposes, and the NR terminology is used in most of the following description, although these technologies can also be applied to applications other than the NR system application, such as the 6^{th} generation (6^{th} Generation, 6G) communication system.

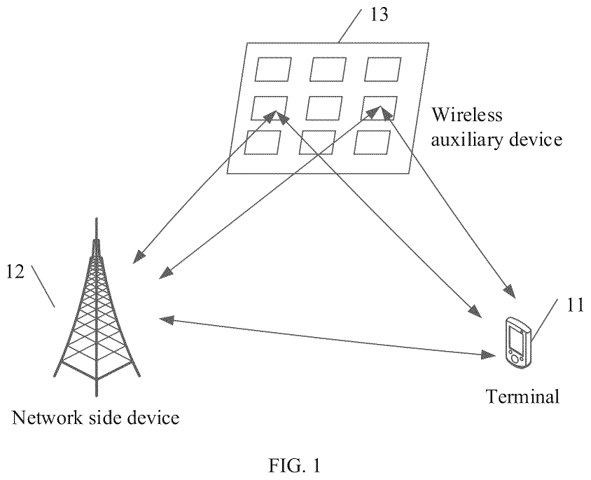

FIG. 1 is a block diagram of a wireless communication system to which embodiments of this application may be applied. The wireless communication system includes a terminal 11, a network side device 12, and a wireless auxiliary device 13. The terminal 11 may be a terminal side device such as a mobile phone, a tablet personal computer, a laptop computer or a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), a smart home (a home device with a wireless communication function, such as a refrigerator, a television, a washing machine, or a furniture), a game console, a Personal Computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, a smart chain, and the like), a smart wrist strap, a smart dress, and the like. It should be noted that a specific type of the terminal 11 is not limited in the embodiments of this application. The network side device 12 may include an access network device or a core network device. The access network device 12 may also be referred to as a radio access network device, a Radio Access Network (RAN), a radio access network function, or a radio access network unit. The access network device 12 may include a base station, a Wireless Local Area Network (WLAN) access point, a Wi-Fi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmitting Receiving Point (TRP), or another appropriate term in the field. Provided that a same technical effect is achieved, the base station is not limited to a specified technical term. It should be noted that, in the embodiments of this application, only a base station in an NR system is used as an example for description, and a specific type of the base station is not limited. The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), a Unified Data Management (UDM), a Unified Data Repository (UDR), a Home Subscriber Server (HSS), a Centralized Network Configuration (CNC), a Network Repository Function (NRF), a Network Exposure Function (NEF), a Local NEF (L-NEF), a Binding Support Function (BSF), an Application Function (AF), and the like. It should be noted that, in the embodiments of this application, only a core network device in an NR system is used as an example for description, and a specific type of the core network device is not limited. The wireless auxiliary device 13 may be a backscatter (backscatter) device with multiple antennas, a relay device with multiple antennas or massive-scale antennas, or another device having both a beamforming function and a signal forwarding function, for example, a Large Intelligent Surfaces (LIS) or a Reconfigurable Intelligent Surfaces (RIS). The RIS may change electric and magnetic properties of the RIS dynamically/semi-statically to affect reflection/refraction of electromagnetic waves that are incident to the RIS. The RIS may control reflection waves/refraction waves of electromagnetic waves to implement functions such as beam sweeping/beamforming.

Abeam control method and apparatus for a wireless auxiliary device and a network side device provided in the embodiments of this application are described below in detail with reference to the accompanying drawings by using some embodiments and application scenarios thereof.

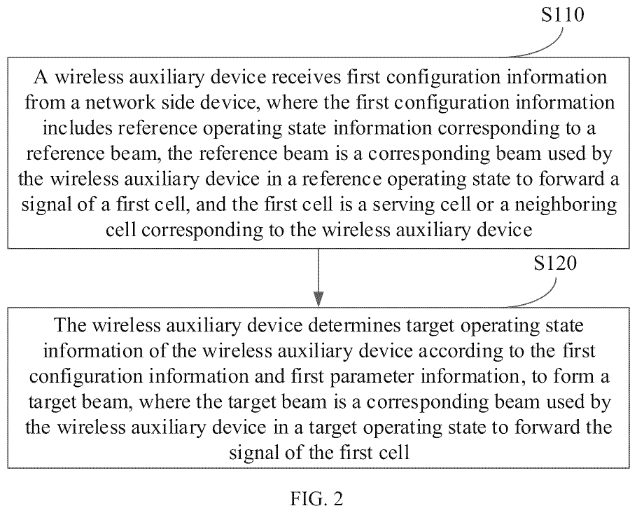

As shown in FIG. 2, an embodiment of this application provides a beam control method for a wireless auxiliary device. In other words, the method may be performed by software or hardware installed in a wireless auxiliary device. The method includes the following steps.

S110: The wireless auxiliary device receives first configuration information from a network side device, where the first configuration information includes reference operating state information corresponding to a reference beam, the reference beam is a corresponding beam used by the wireless auxiliary device in a reference operating state to forward a signal of a first cell, and the first cell is a serving cell or a neighboring cell corresponding to the wireless auxiliary device.

In some implementations, the wireless auxiliary device may be a reconfigurable intelligent surface device. A specific form of the RIS device may be a reflection-type phase-controlled RIS device, a reflection-type power-controlled RIS device, a transmission-type power-controlled RIS device or a transmission-type phase-controlled RIS device, or the like. For simplicity, an example in which the reflection-type phase-controlled RIS device is the wireless auxiliary device is used for description in the following embodiments. In this assumption, a beam of the wireless auxiliary device is a reflection beam of the RIS device.

It should be understood that the RIS device includes a large quantity of regularly arranged RIS hardware units, and a quantity of hardware units included in the RIS device may be set according to actual requirements, and may be several hundreds or thousands. Each hardware unit or a hardware unit group including several adjacent hardware units requires corresponding control information to adjust a state of the hardware unit, that is, a phase of a forwarding signal is adjusted, a set of states of all hardware units is operating state information of the RIS device, and radio signals are reflected to form a beam at the integral viewpoint.

The beam is signal space energy distribution that meets a system requirement or a terminal measurement feedback, to maximize energy of the forwarding signal of the RIS device in a specific direction or a specific area of a system, and obtain a beam gain.

The reference beam is a beam obtained by the network side device based on a measurement result of beam sweeping performed by the wireless auxiliary device on the first cell, and may be considered as a beam with strongest beam direction energy/largest beam enhancement obtained after the beam sweeping.

A target beam is a beam obtained based on the reference beam after parameter adjustment is performed according to first parameter information, a specific direction or a specific area corresponding to the target beam corresponds to a specific direction/beam gain direction or a specific area/beam gain area corresponding to the reference beam. It may be understood that an adjustment target of a first parameter is to enable the specific direction or the specific area corresponding to the target beam to meet a system-specified beam gain.

It should be understood that the network side device is a base station of a serving cell of the wireless auxiliary device.

In an implementation, the first configuration information sent by the network side device may include an Identifier (ID) of the first cell and the reference operating state information corresponding to the corresponding reference beam. In some implementations, the reference operating state information may be explicitly indicated by the network side device, for example, the network side device directly indicates an operating state of each hardware unit of the wireless auxiliary device, or a beam ID in a beam set of wireless auxiliary device-based beam sweeping; or may be implicitly indicated. To be specific, the wireless auxiliary device generates the reference operating state information based on the first configuration information. For example, the first configuration information includes a radio signal incidence direction/Angle of Arrival (AOA)/radio signal source coordinates and a radiation direction/Angle of Departure (AOD)/beam coverage area coordinates.

S120: The wireless auxiliary device determines target operating state information of the wireless auxiliary device according to the first configuration information and the first parameter information, to form the target beam, where the target beam is a corresponding beam used by the wireless auxiliary device in a target operating state to forward the signal of the first cell.

It should be understood that the first parameter information is used to determine control information for the wireless auxiliary device. The wireless auxiliary device may use the reference beam in the first configuration information as an initial beam, and then adjust an operating state of the wireless auxiliary device according to the control information determined based on the first parameter information, to obtain the target beam. In other words, the wireless auxiliary device uses the reference operating state as an initial state, and then adjusts the initial state to the final target operating state according to the control information.

A manner of obtaining the first parameter information may include: The first parameter information is predefined by a protocol, predefined by the wireless auxiliary device, or obtained from the network side device. In an implementation, all or a part of the first parameter information may be received from the network side device. For simplicity, an example in which the first parameter information is obtained from the network side device is used for description in the following embodiments.

In an implementation, the control information may be represented as mask information, and the mask information may include an element for each hardware unit, or an element for each hardware unit group.

In an implementation, the first cell is a neighboring cell, that is, an interference cell, and the reference beam is a beam with strongest interference signal energy of the neighboring cell. The first parameter information is a suppression factor for the neighboring cell. The wireless auxiliary device determines the target operating state information according to the reference beam and the suppression factor, to form the target beam, so that an interference signal of the neighboring cell is suppressed.

In another implementation, the first cell is a serving cell, and the reference beam is a beam with strongest signal energy of the serving cell. The first parameter information is a gain control parameter for the serving cell. The wireless auxiliary device determines the target operating state information according to the reference beam and the gain control parameter, and a beam gain of the target beam is less than a beam gain of the reference beam, so that beam gain control on a signal of the serving cell is implemented.

It can be learned from the technical solution in the foregoing embodiment that in this embodiment of this application, the first configuration information is received from the network side device, where the first configuration information includes the reference operating state information corresponding to the reference beam, and the target operating state information of the wireless auxiliary device is determined according to the first configuration information and the first parameter information, to form the target beam. In this way, interference suppression or gain control on the reference beam is implemented.

Based on the foregoing embodiments, as shown in FIG. 3, in some implementations, the step S120 includes:

S121: Determine mask information according to the first parameter information, where each element in the mask information corresponds to each hardware unit or hardware unit group in the wireless auxiliary device, the hardware unit group is an m*n hardware unit matrix, and m and n are positive integers. For example, the hardware unit matrix of the wireless auxiliary device is a hardware unit matrix of M rows and N columns, and the hardware unit group is a hardware unit submatrix of m rows and n columns. In this case, the wireless auxiliary device includes the hardware unit group of M/m rows and N/n columns.

In an implementation, the first parameter information may include the mask information, that is, the wireless auxiliary device directly obtains the mask information from the first parameter information, and the first parameter information sent by the network side device explicitly indicates the mask information, including a mask corresponding to each hardware unit or a mask sequence or a mask matrix corresponding to each hardware unit group.

In another implementation, the first parameter information may further include L mask patterns, the mask pattern is an m*n mask sequence or mask matrix, and m*n is less than a quantity of hardware units included in the wireless auxiliary device. The L mask patterns are selected from a mask pattern candidate set, the mask pattern candidate set is explicitly configured by the network side device or is predefined by a protocol or the wireless auxiliary device, and L is a positive integer. The wireless auxiliary device may reuse the L mask patterns, and extend and cover each hardware unit included in the wireless auxiliary device, to form the mask information of the wireless auxiliary device.

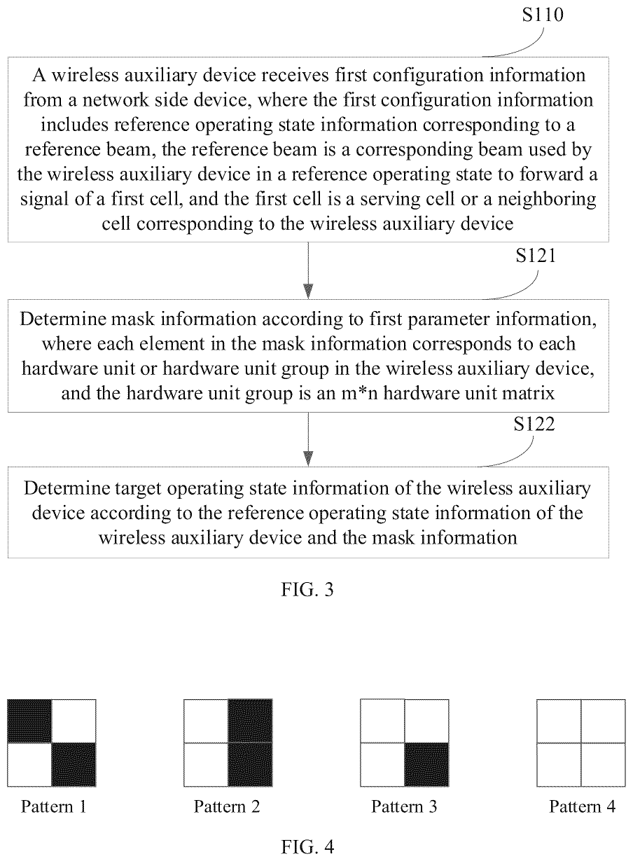

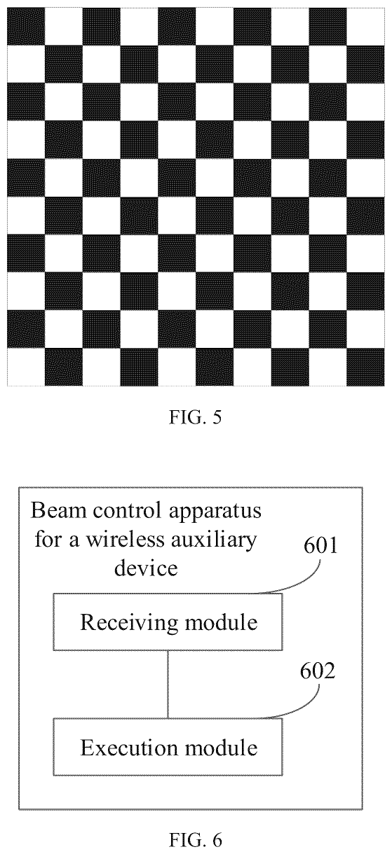

For example, as shown in FIG. 4, the mask pattern candidate set includes four 2*2 mask patterns: a pattern 1, a pattern 2, a pattern 3, and a pattern 4. As shown in FIG. 5, the wireless auxiliary device is a 10*10 hardware unit matrix. In a case that the network side device configures a mask pattern for the wireless auxiliary device: the pattern 1, the wireless auxiliary device may divide the 10*10 hardware unit matrix into 5*5 submatrices according to the pattern 1, each submatrix uses the pattern 1, and the obtained mask information is shown in FIG. 5.

In another implementation, the first parameter information may further include percentages of the L mask patterns in the mask information. As shown above, the mask pattern candidate set shown in FIG. 4 is still used as an example. In this case, the wireless auxiliary device including the 10*10 hardware unit matrix includes 5*5 mask patterns. The network side device configures two mask patterns: the pattern 1 and the pattern 3 according to the first parameter information, and indicates that the pattern 1 accounts for 20% and the pattern 3 accounts for 80%, that is, the pattern 1 appears five times and the pattern 3 appears 20 times. The wireless auxiliary device generates the mask information of the wireless auxiliary device according to the first parameter information, where distribution of the pattern 1 and the pattern 3 may be set to random distribution or generated according to a predefined distribution rule, for example, according to a pseudo random number determining or sequence interleaving rule.

Different patterns in the mask pattern candidate set have different auto-correlation characteristics. For example, in FIG. 4, the pattern 1 has auto-correlation of 0 and the pattern 3 has auto-correlation of 0.5. An auto-correlation characteristic of the mask information generated in the foregoing manner is 0.5*0.8+0*0.2=0.4, that is, a signal amplitude of the target beam obtained through adjustment according to the mask information in a direction of the reference beam becomes 40% of a signal amplitude of the reference beam. It may be understood that for different types of wireless auxiliary devices, calculation manners of auto-correlation characteristics are different. For example, for a phase-controlled RIS device, a calculation manner of an auto-correlation characteristic is Cor=Σ_{i∈mask}e^{j·θi}/Nₘₐₛₖ, where mask represents an element set of a mask, θᵢ represents an adjustment phase corresponding to an i^{th} element in the mask, and Nₘₐₛₖ represents a total quantity of elements in the mask. For another example, for a power-controlled RIS device, a calculation manner of an auto-correlation characteristic is Cor=Σ_{i∈mask} αᵢ/Nₘₐₛₖ, where αᵢ represents an adjustment factor of a signal amplitude corresponding to an i^{th} element.

In another implementation, the first parameter information may further include a target condition of the target beam.

The mask information may be mask information randomly generated by the wireless auxiliary device after the wireless auxiliary device determines the reference operating state information of the wireless auxiliary device according to the received first configuration information; or may be mask information generated based on the reference operating state information and the target condition of the target beam.

In some implementations, in a case that the first parameter information includes the L mask patterns, the step S121 includes:
determining the percentages of the L mask patterns in the mask information according to the target condition of the target beam, and generating the mask information.

In some implementations, the target condition of the target beam includes at least one of the following:
a beam gain of the target beam is less than or equal to a first threshold;
a beam gain of the target beam in a specific direction or a specific area is less than or equal to a second threshold; and
a difference of a beam gain of the target beam relative to a beam gain of the reference beam is in a first range, for example, less than or equal to −3 dB.

For the neighboring cell, the first threshold or the second threshold may be 0, that is, the obtained target beam is required to be able to totally suppress the interference signal of the neighboring cell.

The wireless auxiliary device may calculate the auto-correlation characteristic of the mask information through derivation according to a gain difference of the beam gain of the target beam relative to the beam gain of the reference beam, and generate the mask information according to the auto-correlation characteristic.

The mask information may be expressed in a variety of ways. In an implementation, the mask information may include R-bit (bit) information corresponding to discrete phase control, where R is a positive integer. For example, in a case that the wireless auxiliary device is a 1-bit discrete phase-controlled RIS device, the mask information is also an N-bit mask sequence (SeqMask) consisting of 1-bit information. In a case that the wireless auxiliary device is a 2-bit discrete phase-controlled RIS device, the mask information is also a 2N-bit mask sequence consisting of 2-bit information.

For the 1-bit discrete phase-controlled RIS device, assuming that an element “0” means that a phase state of the hardware unit is unchanged, that is, a phase is adjusted by 0°, and “1” means that a phase state of the hardware unit is flipped, that is, a phase is adjusted by 180°. For another example, for the 2-bit discrete phase-controlled RIS device, “00” means that the phase is adjusted by 0°, “01” means that the phase is adjusted by 90°, “10” means that the phase is adjusted by 180°, and “11” means that the phase is adjusted by 270°.

In another implementation, the mask information may include a real number corresponding to continuous phase control, a state of each hardware unit is represented as a real number, and the mask information may be a real-number sequence with a length of N.

S122: Determine the target operating state information of the wireless auxiliary device according to the reference operating state information of the wireless auxiliary device and the mask information.

In some implementations, the target operating state information of the wireless auxiliary device includes a target state Stateᵢ^{final} corresponding to each hardware unit i in the wireless auxiliary device, and the target state corresponding to the hardware unit i is obtained through calculation according to a reference state Stateᵢ^{initial} of the hardware unit i in the reference operating state information and mask information corresponding to the hardware unit i in the mask information.

In an implementation, the target state Stateᵢ^{final} corresponding to the hardware unit i may be obtained through calculation according to the following formula:

$${State}_{i}^{final} = {F}^{- 1} ( F ( {State}_{i}^{init i a l} ) + F ( {a}_{i}^{m a s k} ) )$$

where Stateᵢ^{initial} is the reference state of the hardware unit i in the reference operating state information, αᵢ^{mask} is the mask information corresponding to the hardware unit i in the mask information, a function F(.) represents a signal state or a signal modulation factor corresponding to a hardware unit state or mask information, and a function F⁻¹(.) is an inverse function of the function F(.).

In an implementation, in a case that the first configuration information includes K pieces of reference beam information and K interference suppression thresholds corresponding to K first cells respectively, cross-correlation results between the target operating state information of the wireless auxiliary device and K pieces of reference operating state information corresponding to reference beams of the K first cells are less than or equal to the interference suppression thresholds of the K first cells respectively.

The cross-correlation results Cor between the target operating state information {Stateᵢ^{final}}_{Matrix} and the reference operating state information {Stateᵢ^{initial}}_{Matrix} corresponding to the reference beams of the K first cells are obtained according to the following formula:

$$C or = {\sum }_{i ∈ RISMatrix} exp ( j * ( F ( {State}_{i}^{final} ) - F ( {State}_{i}^{i n i t i a l} ) ) ) / N$$

where Matrix represents a hardware unit matrix of the wireless auxiliary device, N is a quantity of hardware units in the wireless auxiliary device, j is a unit of a complex imaginary part.

It can be learned from the technical solution in the foregoing embodiment that in this embodiment of this application, the mask information is determined according to the first parameter information, and the target operating state information of the wireless auxiliary device is determined according to the reference operating state information of the wireless auxiliary device and the mask information. In this way, interference suppression or gain control on the reference beam is implemented.

Based on the foregoing embodiment, in some implementations, to determine the reference beam, wireless auxiliary device-based beam sweeping needs to be first performed on the first cell, and the reference beam is determined according to a measurement result of the beam sweeping. Before step S110, the method further includes:
receiving second configuration information from the network side device, where the second configuration information is used to configure, for the wireless auxiliary device, a related parameter for performing wireless auxiliary device-based beam sweeping, and a measurement result of the beam sweeping is used to determine the reference beam.

It should be understood that signal measurement of the wireless auxiliary device-based beam sweeping on the first cell is mainly a downlink procedure. Because a terminal accesses a serving cell, a neighboring cell does not know presence of the terminal. As a result, a base station of the neighboring cell cannot measure interference on the terminal by scheduling a Sounding Reference Signal (SRS).

In some implementations, the second configuration information includes at least one of the following:
candidate beam information of the wireless auxiliary device; and
configuration information of a to-be-measured reference signal of the first cell, where the to-be-measured reference signal may be a Synchronization Signal and PBCH Block (SSB), a Channel State Information Reference Signal (CSI-RS), or the like.

In some implementations, the candidate beam information of the wireless auxiliary device includes at least one of the following:
a set of candidate beams, where the set of candidate beams may be preconfigured at delivery of the wireless auxiliary device, or preconfigured when the wireless auxiliary device is deployed;
execution time of each candidate beam and execution time of state switching of each candidate beam, where the execution time may include an execution cycle, a specific operating time period, or the like; and
control information, of the wireless auxiliary device, corresponding to each candidate beam.

It should be understood that the control information, of the wireless auxiliary device, corresponding to each candidate beam may be explicitly indicated by the network side device, or selected from the set of candidate beams, or autonomously generated by a control module of the wireless auxiliary device according to configuration information related to the candidate beam. The configuration information related to the candidate beam may include space of the candidate beam, such as a directional angle of an incident signal and a directional angle of a forwarding beam.

The state switching of the candidate beam is obtained by flipping the phase of each hardware unit in the wireless auxiliary device. For example, for the 1-bit discrete phase-controlled RIS device, “00 . . . 00” means that a phase state of each hardware unit is unchanged, that is, an initial phase is maintained, and “11 . . . 11” means that a phase of each hardware unit is flipped by 180°. Accordingly, for the 2-bit discrete phase-controlled RIS device or a higher-order discrete phase-controlled RIS device, corresponding phase flip may alternatively be 90°, 270° or other specified phase flip.

It may be understood that an operating time period of an initial phase of the candidate beam and an operating time period of the corresponding phase flip each may include multiple time periods. For example, the operating time period of the initial phase of the candidate beam is a symbol 0 and a symbol 7 in a slot 0, and the operating time period of the corresponding phase flip is a symbol 3 and a symbol 10 in the slot 0.

Accordingly, in addition to sending the second configuration information to the wireless auxiliary device, the network side device further sends third configuration information to the terminal, to configure, for the terminal, a related parameter for performing wireless auxiliary device-based beam sweeping.

In an implementation, the third configuration information includes the configuration information of the to-be-measured reference signal of the first cell.

In some implementations, the configuration information of the to-be-measured reference signal of the first cell includes at least one of the following:
an identifier of the first cell;
a port number of the to-be-measured reference signal;
beam configuration information of the to-be-measured reference signal; and time-frequency resource configuration information of the to-be-measured reference signal.

It may be understood that execution time of the to-be-measured reference signal in the time-frequency resource configuration information of the to-be-measured reference signal corresponds to the corresponding execution time of the candidate beam. The execution time of the candidate beam is the same as execution time of the to-be-measured reference signal corresponding to execution time of the phase flip.

For example, for an SSB signal, the operating time period of the initial phase of the candidate beam and the operating time period of the flipped phase may correspond to a Primary Synchronization Signal (PSS) symbol and a Secondary Synchronization Signal (SSS) symbol in the SSB respectively.

For another example, for a CSI-RS signal, the operating time period of the initial phase of the candidate beam and the operating time period of the flipped phase may correspond to two different non zero power CSI-RS (NonZeroPower CSI-RS, NZP CSI-RS) symbols in a slot respectively.

In some implementations, the signal, of the first cell, corresponding to execution time of the beam sweeping is on a same transmit beam.

The terminal measures candidate beams in a beam sweeping process, and determines a candidate beam with strongest energy or optimal signal quality, the energy of the candidate beam with the strongest energy, and the signal quality of the candidate beam with the optimal signal quality. A measurement result of the candidate beam may be Reference Signal Received Power (RSRP), Reference Signal Received Quality (RSRQ), or a Signal-to-Noise and Interference Ratio (SINR).

It may be understood that in a case that the first cell is a neighboring cell, the network side device configures a to-be-measured reference signal of the neighboring cell for the terminal, such as an SSB or a CSI-RS, and the terminal may obtain signal strength of the candidate beam according to the candidate beam and a corresponding phase-flipped beam. In a case that the first cell is a serving cell, the network side device configures a to-be-measured reference signal of the serving cell for the terminal, such as an NZP CSI-RS, and the terminal measures signal quality of a superimposed signal of the candidate beam and another path.

The terminal measures the operating time period of the candidate beam and obtains a channel estimation result H₁=hₙₒᵣₘₐₗ+h_{RIS}. The terminal measures the corresponding phase-flipped beam of the candidate beam and obtains a channel estimation result H₁=hₙₒᵣₘₐₗ+h_{RIS}e^{jθ}. hₙₒᵣₘₐₗ represents a channel response to the signal of the first cell propagating to the terminal on another path, h_{RIS} represents a channel response to the signal of the first cell reaching the terminal through the candidate beam, and 0 represents the flipped phase. According to the foregoing measured channel information, the terminal may determine channel information h_{RIS} and signal quality of the candidate beam, and measure channel information hₙₒᵣₘₐₗ and signal quality of the first cell on another transmission path.

The terminal reports the foregoing measurement result to the network side device after completing the beam sweeping, so that the network side device determines the reference beam of the first cell and sends the first configuration information to the wireless auxiliary device.

It can be learned from the technical solution in the foregoing embodiment that in this embodiment of this application, the second configuration information is received from the network side device, where the second configuration information is used to configure, for the wireless auxiliary device, the related parameter for performing wireless auxiliary device-based beam sweeping, so that the network side device determines the reference beam of the first cell according to the result of the beam sweeping. In this way, interference suppression or gain control on the reference beam is implemented.

The beam control method for a wireless auxiliary device provided in the embodiments of this application may be performed by a beam control apparatus for a wireless auxiliary device. In the embodiments of this application, an example in which the beam control apparatus for a wireless auxiliary device performs the beam control method for a wireless auxiliary device is used to describe the beam control apparatus for a wireless auxiliary device provided in the embodiments of this application.

As shown in FIG. 6, the beam control apparatus includes a receiving module 601 and an execution module 602.

The receiving module 601 is configured to receive first configuration information from a network side device, where the first configuration information includes reference operating state information corresponding to a reference beam, the reference beam is a corresponding beam used by the beam control apparatus in a reference operating state to forward a signal of a first cell, and the first cell is a serving cell or a neighboring cell corresponding to the beam control apparatus. The execution module 602 is configured to determine target operating state information according to the first configuration information and first parameter information, to form a target beam, where the target beam is a corresponding beam used by the beam control apparatus in a target operating state to forward the signal of the first cell.

In some implementations, the beam control apparatus is a reconfigurable intelligent surface device.

It can be learned from the foregoing embodiment that in this embodiment of this application, the first configuration information is received from the network side device, where the first configuration information includes the reference operating state information corresponding to the reference beam, and then the target operating state information is determined according to the first configuration information and the first parameter information, to form the target beam. In this way, interference suppression or gain control on the reference beam is implemented.

Based on the foregoing embodiment, in some implementations, the receiving module 601 is configured to:
determine mask information according to the first parameter information, where each element in the mask information corresponds to each hardware unit or hardware unit group in the beam control apparatus, the hardware unit group is an m*n hardware unit matrix, and m and n are positive integers; and
determine the target operating state information according to the reference operating state information and the mask information.

In some implementations, the first parameter information includes at least one of the following:
the mask information;
L mask patterns, where the mask pattern is an m*n mask sequence or mask matrix, the L mask patterns are selected from a mask pattern candidate set, and L is a positive integer;
percentages of the L mask patterns in the mask information; and
a target condition of the target beam.

In some implementations, the target condition of the target beam includes at least one of the following:
a beam gain of the target beam is less than or equal to a first threshold;
a beam gain of the target beam in a specific direction or a specific area is less than or equal to a second threshold; and
a difference of a beam gain of the target beam relative to a beam gain of the reference beam is in a first range.

In some implementations, in a case that the first parameter information includes the L mask patterns, the determining mask information according to the first parameter information includes:
determining the percentages of the L mask patterns in the mask information according to the target condition of the target beam, and generating the mask information.

In some implementations, before the determining mask information according to the first parameter information, the method further includes:
receiving all or a part of the first parameter information from the network side device.

In some implementations, the mask information includes at least one of the following:
R-bit information corresponding to discrete phase control, where R is a positive integer; and
a real number corresponding to continuous phase control.

In some implementations, the target operating state information includes a target state corresponding to each hardware unit I in the beam control apparatus, and the target state corresponding to the hardware unit i is obtained through calculation according to a reference state of the hardware unit i in the reference operating state information and mask information corresponding to the hardware unit i in the mask information.

In some implementations, the target state Stateᵢ^{final} corresponding to the hardware unit i is obtained through calculation according to the following formula:

$${State}_{i}^{final} = {F}^{- 1} ( F ( {State}_{i}^{init i a l} ) + F ( {a}_{i}^{m a s k} ) )$$

where Stateᵢ^{initial} is the reference state of the hardware unit i in the reference mask operating state information, αₐ^{mask} is the mask information corresponding to the hardware unit i in the mask information, a function F(.) represents a signal state or a signal modulation factor corresponding to a hardware unit state or mask information, and a function F⁻¹(.) is an inverse function of the function F(.).

In some implementations, in a case that the first configuration information includes K pieces of reference beam information and K interference suppression thresholds corresponding to K first cells respectively, cross-correlation results between the target operating state information and K pieces of reference operating state information corresponding to reference beams of the K first cells are less than or equal to correlation thresholds corresponding to the interference suppression thresholds of the K first cells respectively. The wireless auxiliary device generates the target operating state information according to the correlation threshold. In particular, the K first cells include one serving cell and K-1 neighboring cell. The wireless auxiliary device uses operating state information corresponding to a beam of the serving cell as reference beam operating state information, and generates the target operating state information, to ensure that cross-correlation characteristics between the target operating state information and operating state information corresponding to the K-1 neighboring cells meet a requirement of the correlation threshold.

It can be learned from the technical solution in the foregoing embodiment that in this embodiment of this application, the mask information is determined according to the first parameter information, and the target operating state information is determined according to the reference operating state information and the mask information. In this way, interference suppression or gain control on the reference beam is implemented.

Based on the foregoing embodiment, in some implementations, the receiving module 601 is further configured to: receive second configuration information from the network side device, where the second configuration information is used to configure, for the beam control apparatus, a related parameter for performing beam control apparatus-based beam sweeping, and a measurement result of the beam sweeping is used to determine the reference beam.

In some implementations, the second configuration information includes at least one of the following:
candidate beam information; and
configuration information of a to-be-measured reference signal of the first cell.

In some implementations, the candidate beam information includes at least one of the following:
a set of candidate beams;
execution time of each candidate beam and execution time of state switching of each candidate beam; and
control information, of the beam control apparatus, corresponding to each candidate beam.

In some implementations, the configuration information of the to-be-measured reference signal of the first cell includes at least one of the following:
an identifier of the first cell;
a port number of the to-be-measured reference signal;
beam configuration information of the to-be-measured reference signal; and
time-frequency resource configuration information of the to-be-measured reference signal.

It can be learned from the technical solution in the foregoing embodiment that in this embodiment of this application, the second configuration information is received from the network side device, where the second configuration information is used to configure, for the wireless auxiliary device, the related parameter for performing wireless auxiliary device-based beam sweeping, so that the network side device determines the reference beam of the first cell according to the result of the beam sweeping. In this way, interference suppression or gain control on the reference beam is implemented.

The beam control apparatus for a wireless auxiliary device in this embodiment of this application may be an electronic device, for example, an electronic device having an operating system, or may be a component in the electronic device, for example, an integrated circuit or a chip. The electronic device may be a terminal, or another device other than the terminal. For example, the terminal may include but is not limited to the foregoing listed types of the terminal 11. The another device may be a server, a Network Attached Storage (NAS), or the like. This is not specifically limited in this embodiment of this application.

The beam control apparatus for a wireless auxiliary device provided in this embodiment of this application can implement the processes implemented in the method embodiments in FIG. 2 to FIG. 5, and achieve a same technical effect. To avoid repetition, details are not described herein again.

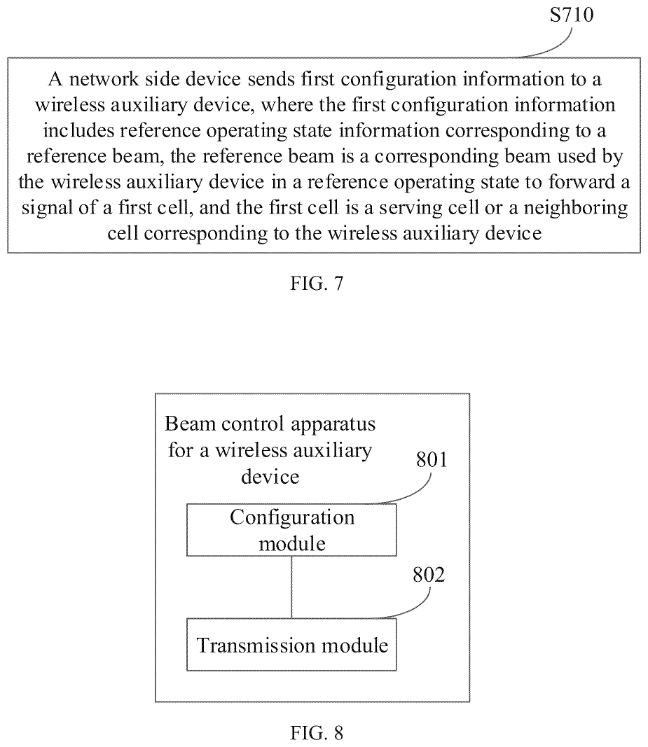

As shown in FIG. 7, an embodiment of this application provides a beam control method for a wireless auxiliary device. The method is performed by a network side device. In other words, the method may be performed by software or hardware installed in the network side device. The method includes the following step.

S710: The network side device sends first configuration information to a wireless auxiliary device, where the first configuration information includes reference operating state information corresponding to a reference beam, the reference beam is a corresponding beam used by the wireless auxiliary device in a reference operating state to forward a signal of a first cell, and the first cell is a serving cell or a neighboring cell corresponding to the wireless auxiliary device.

Step S710 may implement the method embodiment shown in FIG. 2, and achieve a same technical effect. Repeated parts are not described herein again.

It can be learned from the technical solution of the foregoing embodiment, in this embodiment of this application, the first configuration information is sent to the wireless auxiliary device, where the first configuration information includes the reference operating state information corresponding to the reference beam, so that the wireless auxiliary device can determine target operating state information according to the first configuration information and first parameter information, to form a target beam. In this way, interference suppression or gain control on the reference beam is implemented.

Based on the foregoing embodiment, in some implementations, the method further includes:

The network side device sends all or a part of the first parameter information to the wireless auxiliary device, where
the first parameter information is used to enable the wireless auxiliary device to determine the target operating state information, and the first parameter information includes at least one of the following:
mask information, where each element in the mask information corresponds to each hardware unit or hardware unit group in the wireless auxiliary device, the hardware unit group is an m*n hardware unit matrix, and m and n are positive integers;
L mask patterns, where the mask pattern is an m*n mask sequence or mask matrix, and L, m, and n are positive integers;
percentages of the L mask patterns in the mask information; and
a target condition of the target beam.

In some implementations, the target condition of the target beam includes at least one of the following:
a beam gain of the target beam is less than a first threshold;
a beam gain of the target beam in a specific direction or a specific area is less than a second threshold; and
a difference of a beam gain of the target beam relative to a beam gain of the reference beam is in a first range.

This embodiment of this application may implement the method embodiments shown in FIG. 3 to FIG. 5, and achieve a same technical effect. Repeated parts are not described herein again.

It can be learned from the technical solution of the foregoing embodiment, in this embodiment of this application, all or the part of the first parameter information is sent to the wireless auxiliary device, to determine the target operating state information of the wireless auxiliary device. In this way, interference suppression or gain control on the reference beam is implemented.

Based on the foregoing embodiment, in some implementations, before the sending first configuration information to a wireless auxiliary device, the method further includes:

The network side device sends second configuration information to the wireless auxiliary device, and sends third configuration information to a terminal, where the second configuration information and the third configuration information are used to configure, for the wireless auxiliary device and the terminal respectively, a related parameter for performing wireless auxiliary device-based beam sweeping.

The network side device receives a measurement result of the beam sweeping from the terminal, and determines the reference beam based on the measurement result.

In some implementations, the second configuration information includes:
candidate beam information of the wireless auxiliary device; and
configuration information of a to-be-measured reference signal of the first cell.

In some implementations, the candidate beam information of the wireless auxiliary device includes at least one of the following:
a set of candidate beams;
execution time of each candidate beam and execution time of state switching of each candidate beam of the wireless auxiliary device; and
control information, of the wireless auxiliary device, corresponding to each candidate beam.

In some implementations, the third configuration information includes:
the configuration information of the to-be-measured reference signal of the first cell.

In some implementations, the configuration information of the to-be-measured reference signal of the first cell includes at least one of the following:
an ID of the first cell;
a port number of the to-be-measured reference signal;
beam configuration information of the to-be-measured reference signal; and
time-frequency resource configuration information of the to-be-measured reference signal.

This embodiment of this application may implement the beam sweeping process described above, and achieve a same technical effect. Repeated parts are not described herein again.

It can be learned from the technical solution of the foregoing embodiment, in this embodiment of this application, the second configuration information is sent to the wireless auxiliary device, and the third configuration information is sent to the terminal, so that the network side device determines the reference beam of the first cell according to the result of the beam sweeping. In this way, interference suppression or gain control on the reference beam is implemented.

The beam control method for a wireless auxiliary device provided in the embodiments of this application may be performed by a beam control apparatus for a wireless auxiliary device. In the embodiments of this application, an example in which the beam control apparatus for a wireless auxiliary device performs the beam control method for a wireless auxiliary device is used to describe the beam control apparatus for a wireless auxiliary device provided in the embodiments of this application.

As shown in FIG. 8, the beam control apparatus includes a configuration module 801 and a transmission module 802.

The configuration module 801 is configured to obtain first configuration information; and the transmission module 802 sends the first configuration information to a wireless auxiliary device, where the first configuration information includes reference operating state information corresponding to a reference beam, the reference beam is a corresponding beam used by the wireless auxiliary device in a reference operating state to forward a signal of a first cell, and the first cell is a serving cell or a neighboring cell corresponding to the wireless auxiliary device.

It can be learned from the technical solution of the foregoing embodiment, in this embodiment of this application, the first configuration information is sent to the wireless auxiliary device, where the first configuration information includes the reference operating state information corresponding to the reference beam, so that the wireless auxiliary device can determine target operating state information according to the first configuration information and first parameter information, to form a target beam. In this way, interference suppression or gain control on the reference beam is implemented.

Based on the foregoing embodiment, in some implementations, the transmission module 802 is further configured to send all or a part of the first parameter information to the wireless auxiliary device.

The first parameter information is used to enable the wireless auxiliary device to determine the target operating state information, and the first parameter information includes at least one of the following:
mask information, where each element in the mask information corresponds to each hardware unit or hardware unit group in the wireless auxiliary device, the hardware unit group is an m*n hardware unit matrix, and m and n are positive integers;
L mask patterns, where the mask pattern is an m*n mask sequence or mask matrix, and L, m, and n are positive integers;
percentages of the L mask patterns in the mask information; and
a target condition of the target beam.

In some implementations, the target condition of the target beam includes at least one of the following:
a beam gain of the target beam is less than a first threshold;
a beam gain of the target beam in a specific direction or a specific area is less than a second threshold; and
a difference of a beam gain of the target beam relative to a beam gain of the reference beam is in a first range.

It can be learned from the technical solution of the foregoing embodiment, in this embodiment of this application, all or the part of the first parameter information is sent to the wireless auxiliary device, to determine the target operating state information of the wireless auxiliary device. In this way, interference suppression or gain control on the reference beam is implemented.

Based on the foregoing embodiment, in some implementations, the transmission module 802 is further configured to:
send second configuration information to the wireless auxiliary device, and send third configuration information to a terminal, where the second configuration information and the third configuration information are used to configure, for the wireless auxiliary device and the terminal respectively, a related parameter for performing wireless auxiliary device-based beam sweeping; and
receive a measurement result of the beam sweeping from the terminal, and determine the reference beam based on the measurement result.

In some implementations, the second configuration information includes:
candidate beam information of the wireless auxiliary device; and
configuration information of a to-be-measured reference signal of the first cell.

In some implementations, the candidate beam information of the wireless auxiliary device includes at least one of the following:
a set of candidate beams;
execution time of each candidate beam and execution time of state switching of each candidate beam of the wireless auxiliary device; and
control information, of the wireless auxiliary device, corresponding to each candidate beam.

In some implementations, the third configuration information includes:
the configuration information of the to-be-measured reference signal of the first cell.

In some implementations, the configuration information of the to-be-measured reference signal of the first cell includes at least one of the following:
an ID of the first cell;
a port number of the to-be-measured reference signal;
beam configuration information of the to-be-measured reference signal; and time-frequency resource configuration information of the to-be-measured reference signal.

It can be learned from the technical solution of the foregoing embodiment, in this embodiment of this application, the second configuration information is sent to the wireless auxiliary device, and the third configuration information is sent to the terminal, so that the reference beam of the first cell is determined according to the result of the beam sweeping. In this way, interference suppression or gain control on the reference beam is implemented.

The beam control apparatus for a wireless auxiliary device in this embodiment of this application may be an electronic device, for example, an electronic device having an operating system, or may be a component in the electronic device, for example, an integrated circuit or a chip. The electronic device may be a terminal, or another device other than the terminal. For example, the terminal may include but is not limited to the foregoing listed types of the terminal 11. The another device may be a server, a NAS, or the like. This is not specifically limited in this embodiment of this application.

The beam control apparatus for a wireless auxiliary device provided in this embodiment of this application can implement the processes implemented in the method embodiment in FIG. 7, and achieve a same technical effect. To avoid repetition, details are not described herein again.

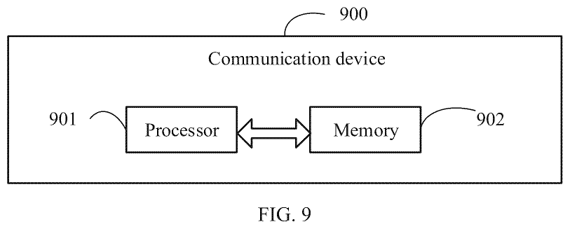

In some implementations, as shown in FIG. 9, an embodiment of this application further provides a communications device 900, including a processor 901 and a memory 902. The memory 902 stores a program or an instruction that is executable on the processor 901. For example, in a case that the communications device 900 is a terminal, the program or the instruction is executed by the processor 901 to implement the steps of the embodiment of the beam control method for a wireless auxiliary device, and a same technical effect can be achieved. In a case that the communication device 900 is a network side device, the program or the instruction is executed by the processor 901 to implement the steps of the embodiment of the beam control method for a wireless auxiliary device, and a same technical effect can be achieved. To avoid repetition, details are not described herein again.

An embodiment of this application further provides a terminal, including a processor and a communication interface. The processor is configured to perform wireless auxiliary device-based beam sweeping according to third configuration information. The communication interface is configured to receive the third configuration information from a network side device; and report a measurement result of the beam sweeping to the network side device. The terminal embodiment corresponds to the terminal side method embodiment, each implementation process and implementation of the method embodiment can be applied to the terminal embodiment, and a same technical effect can be achieved.

An embodiment of this application further provides a network side device, including a processor and a communication interface. The processor is configured to obtain first configuration information. The communication interface is configured to send the first configuration information to a wireless auxiliary device. The network side device embodiment corresponds to the method embodiment of the network side device, each implementation process and implementation of the method embodiment can be applied to the network side device embodiment, and a same technical effect can be achieved.

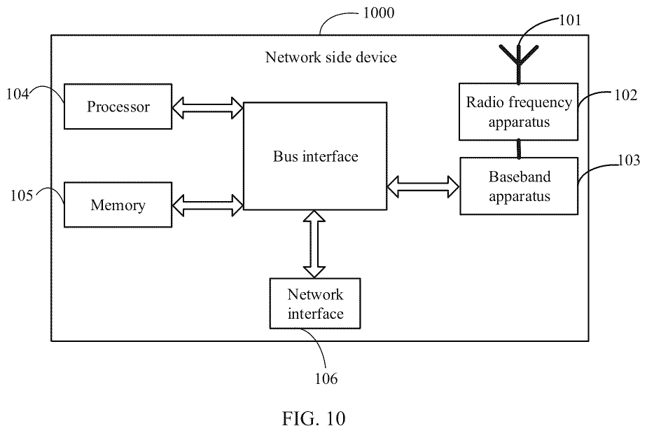

In some implementations, an embodiment of this application further provides a network side device. As shown in FIG. 10, the network side device 1000 includes an antenna 101, a radio frequency apparatus 102, a baseband apparatus 103, a processor 104, and a memory 105. The antenna 101 is connected to the radio frequency apparatus 102. In an uplink direction, the radio frequency apparatus 102 receives information through the antenna 101, and sends the received information to the baseband apparatus 103 for processing. In a downlink direction, the baseband apparatus 103 processes information that needs to be sent, and sends processed information to the radio frequency apparatus 102. The radio frequency apparatus 102 processes the received information, and sends processed information through the antenna 101.

In the foregoing embodiment, the method performed by the network side device may be implemented in the baseband apparatus 103. The baseband apparatus 103 includes a baseband processor.

For example, the baseband apparatus 103 may include at least one baseband board. Multiple chips are disposed on the baseband board. As shown in FIG. 10, one chip is, for example, a baseband processor, and is connected to the memory 105 through a bus interface, to invoke a program in the memory 105 to perform the operations of the network side device shown in the foregoing method embodiments.

The network side device may further include a network interface 106, and the interface is, for example, a Common Public Radio Interface (CPRI).

In some implementations, the network side device 1000 in this embodiment of the present disclosure further includes an instruction or a program that is stored in the memory 105 and that is executable on the processor 104. The processor 104 invokes the instruction or the program in the memory 105 to perform the method performed by the modules shown in FIG. 8, and a same technical effect is achieved. To avoid repetition, details are not described herein again.

An embodiment of this application further provides a readable storage medium. The readable storage medium stores a program or an instruction, and the program or the instruction is executed by a processor to implement the processes of the foregoing embodiment of the beam control method for a wireless auxiliary device, and a same technical effect can be achieved. To avoid repetition, details are not described herein again.

The processor is a processor in the terminal in the foregoing embodiments. The readable storage medium includes a computer-readable storage medium, for example, a Read Only Memory (ROM), a Random Access Memory (RAM), a magnetic disk, or an optical disc.

An embodiment of this application further provides a chip. The chip includes a processor and a communication interface, the communication interface is coupled to the processor, and the processor is configured to run a program or an instruction to implement the processes of the foregoing embodiment of the beam control method for a wireless auxiliary device, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a storage medium, and the computer program/program product is executed by at least one processor to implement the processes of the foregoing embodiment of the beam control method for a wireless auxiliary device, and a same technical effect can be achieved. To avoid repetition, details are not described herein again.

An embodiment of this application further provides a beam control system for a wireless auxiliary device, including: a terminal, a wireless auxiliary device, and a network side device. The terminal may be configured to perform the steps of the beam control method for a wireless auxiliary device. The wireless auxiliary device is configured to perform the steps of the beam control method for a wireless auxiliary device. The network side device may be configured to perform the steps of the beam control method for a wireless auxiliary device.

It should be noted that, in this specification, the term “include,” “comprise,” or any other variant thereof is intended to cover a non-exclusive inclusion, so that a process, a method, an article, or an apparatus that includes a list of elements not only includes those elements but also includes other elements that are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the method and apparatuses in the embodiments of this application is not limited to performing functions in the order shown or discussed, but may also include performing the functions in a basically simultaneous manner or in opposite order based on the functions involved. For example, the described method may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. Based on such an understanding, the technical solutions of this application essentially or the part contributing to the related art may be implemented in a form of a computer software product. The computer software product is stored in a storage medium (for example, a ROM/RAM, a magnetic disk, or an optical disc), and includes several instructions for instructing a terminal (which may be a mobile phone, a computer, a server, an air conditioner, a network device, or the like) to perform the method described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. A beam control method, performed by a wireless auxiliary device, comprising:
receiving first configuration information from a network side device, wherein the first configuration information comprises reference operating state information corresponding to a reference beam, the reference beam is a corresponding beam used by the wireless auxiliary device in a reference operating state to forward a signal of a first cell, and the first cell is a serving cell or a neighboring cell corresponding to the wireless auxiliary device; and
determining target operating state information of the wireless auxiliary device according to the first configuration information and first parameter information, to form a target beam, wherein the target beam is a corresponding beam used by the wireless auxiliary device in a target operating state to forward the signal of the first cell.

2. The beam control method according to claim 1, wherein the determining target operating state information of the wireless auxiliary device according to the first configuration information and first parameter information comprises:
determining mask information according to the first parameter information, wherein each element in the mask information corresponds to each hardware unit or hardware unit group in the wireless auxiliary device, the hardware unit group is an m*n hardware unit matrix, and m and n are positive integers; and
determining the target operating state information of the wireless auxiliary device according to the reference operating state information of the wireless auxiliary device and the mask information.

3. The beam control method according to claim 2, wherein the first parameter information comprises at least one of the following:
the mask information;
L mask patterns, wherein the mask pattern is an m*n mask sequence or mask matrix, the L mask patterns are selected from a mask pattern candidate set, the mask pattern candidate set is explicitly configured by the network side device or is predefined by a protocol or the wireless auxiliary device, and L is a positive integer;
percentages of the L mask patterns in the mask information; or
a target condition of the target beam.

4. The beam control method according to claim 3, wherein the target condition of the target beam comprises at least one of the following:
a beam gain of the target beam is less than or equal to a first threshold;
a beam gain of the target beam in a specific direction or a specific area is less than or equal to a second threshold; or
a difference of a beam gain of the target beam relative to a beam gain of the reference beam is in a first range.

5. The beam control method according to claim 3, wherein when the first parameter information comprises the L mask patterns, the determining mask information according to the first parameter information comprises:
determining the percentages of the L mask patterns in the mask information according to the target condition of the target beam, and generating the mask information.

6. The beam control method according to claim 2, wherein before the determining mask information according to the first parameter information, the beam control method further comprises:
receiving all or a part of the first parameter information from the network side device.

7. The beam control method according to claim 2, wherein the mask information comprises at least one of the following:
R-bit information corresponding to discrete phase control, wherein R is a positive integer; or
a real number corresponding to continuous phase control.

8. The beam control method according to claim 7, wherein the target operating state information of the wireless auxiliary device comprises a target state corresponding to each hardware unit i in the wireless auxiliary device, and the target state corresponding to the hardware unit i is obtained through calculation according to a reference state of the hardware unit i in the reference operating state information and mask information corresponding to the hardware unit i in the mask information.

9. The beam control method according to claim 8, wherein the target state Stateᵢ^{final} corresponding to the hardware unit i is obtained through calculation according to the following formula:
$${State}_{i}^{final} = {F}^{- 1} ( F ( {State}_{i}^{init i a l} ) + F ( {a}_{i}^{m a s k} ) )$$
wherein Stateᵢ^{initial} is the reference state of the hardware unit i in the reference operating state information, αᵢ^{mask} is the mask information corresponding to the hardware unit i in the mask information, a function F(.) represents a signal state or a signal modulation factor corresponding to a hardware unit state or mask information, and a function F⁻¹(.) is an inverse function of the function F(.).

10. The beam control method according to claim 1, wherein when the first configuration information comprises K pieces of reference beam information and K interference suppression thresholds corresponding to K first cells respectively, cross-correlation results between the target operating state information of the wireless auxiliary device and K pieces of reference operating state information corresponding to reference beams of the K first cells are less than or equal to the interference suppression thresholds of the K first cells respectively.

11. The beam control method according to claim 1, wherein before the receiving first configuration information from a network side device, the beam control method further comprises:
receiving second configuration information from the network side device, wherein the second configuration information is used to configure, for the wireless auxiliary device, a related parameter for performing wireless auxiliary device-based beam sweeping, and a measurement result of the beam sweeping is used to determine the reference beam, wherein the second configuration information comprises at least one of the following:
candidate beam information of the wireless auxiliary device; or
configuration information of a to-be-measured reference signal of the first cell.

12. The beam control method according to claim 11, wherein the candidate beam information of the wireless auxiliary device comprises at least one of the following:
a set of candidate beams;
execution time of each candidate beam and execution time of state switching of each candidate beam; or
control information, of the wireless auxiliary device, corresponding to each candidate beam; or
wherein the configuration information of the to-be-measured reference signal of the first cell comprises at least one of the following:
an identifier of the first cell;
a port number of the to-be-measured reference signal;
beam configuration information of the to-be-measured reference signal; or
time-frequency resource configuration information of the to-be-measured reference signal.

13. The beam control method according to claim 1, wherein the wireless auxiliary device is a reconfigurable intelligent surface device.

14. Abeam control method, performed by a network side device, comprising:
sending first configuration information to a wireless auxiliary device, wherein the first configuration information comprises reference operating state information corresponding to a reference beam, the reference beam is a corresponding beam used by the wireless auxiliary device in a reference operating state to forward a signal of a first cell, and the first cell is a serving cell or a neighboring cell corresponding to the wireless auxiliary device.

15. The beam control method according to claim 14, wherein the beam control method further comprises:
sending all or a part of first parameter information to the wireless auxiliary device, wherein
the first parameter information is used to enable the wireless auxiliary device to determine target operating state information, and the first parameter information comprises at least one of the following:
mask information, wherein each element in the mask information corresponds to each hardware unit or hardware unit group in the wireless auxiliary device, the hardware unit group is an m*n hardware unit matrix, and m and n are positive integers;
L mask patterns, wherein the mask pattern is an m*n mask sequence or mask matrix, and L, m, and n are positive integers;
percentages of the L mask patterns in the mask information; or
a target condition of a target beam.

16. The beam control method according to claim 15, wherein the target condition of the target beam comprises at least one of the following:
a beam gain of the target beam is less than a first threshold;
a beam gain of the target beam in a specific direction or a specific area is less than a second threshold; or
a difference of a beam gain of the target beam relative to a beam gain of the reference beam is in a first range.

17. The beam control method according to claim 16, wherein before the sending first configuration information to a wireless auxiliary device, the beam control method further comprises:
sending second configuration information to the wireless auxiliary device, and sending third configuration information to a terminal, wherein the second configuration information and the third configuration information are used to configure, for the wireless auxiliary device and the terminal respectively, a related parameter for performing wireless auxiliary device-based beam sweeping; and
receiving a measurement result of the beam sweeping from the terminal, and determining the reference beam based on the measurement result.

18. The beam control method according to claim 17, wherein the second configuration information comprises:
candidate beam information of the wireless auxiliary device; and
configuration information of a to-be-measured reference signal of the first cell; and
wherein the third configuration information comprises:
configuration information of a to-be-measured reference signal of the first cell.

19. The beam control method according to claim 18, wherein the candidate beam information of the wireless auxiliary device comprises at least one of the following:
a set of candidate beams;
execution time of each candidate beam and execution time of state switching of each candidate beam of the wireless auxiliary device; or
control information, of the wireless auxiliary device, corresponding to each candidate beam.

20. The beam control method according to claim 19, wherein the configuration information of the to-be-measured reference signal of the first cell comprises at least one of the following:
an ID of the first cell;
a port number of the to-be-measured reference signal;
beam configuration information of the to-be-measured reference signal; or
time-frequency resource configuration information of the to-be-measured reference signal.
